(19) United States
(12) Patent Application Publication
(10) Pub. No.: US 2025/0330548 A1
(43) Pub. Date: Oct. 23, 2025

(54) INFORMATION PROCESSING APPARATUS, IMAGE FORMING APPARATUS, INFORMATION PROCESSING METHOD, AND NON-TRANSITORY RECORDING MEDIUM

(71) Applicant: Sayaka Yasuda, KANAGAWA (JP)

(72) Inventor: Sayaka Yasuda, KANAGAWA (JP)

(73) Assignee: Ricoh Company, Ltd., Tokyo (JP)

(21) Appl. No.: 19/172,971

(22) Filed: Apr. 8, 2025

(30) Foreign Application Priority Data
Apr. 18, 2024 (JP) 2024-067641

(51) Int. Cl. H04N 1/44

(52) U.S. Cl. CPC H04N 1/4433; H04N 1/442; H04N 1/4426; H04N 2201/0094

(57) ABSTRACT

An information processing apparatus comprising: a memory that stores user information of one or more users who are authorized to use a predetermined system, the user information including user identification information for identifying the user; and circuitry to monitor presence of a user who uses the predetermined system, authenticate the user based on the user information, and reset authentication information of the user or an operation screen of the predetermined system, when the circuitry detects that the user has left the predetermined system beyond a predetermined range after authentication of the user and before the user completes a use of the predetermined system.

### CROSS-REFERENCE TO RELATED APPLICATIONS

This patent application is based on and claims priority pursuant to 35 U.S.C. § 119 (a) to Japanese Patent Application No. 2024-067641, filed on Apr. 18, 2024, in the Japan Patent Office, the entire disclosure of which is hereby incorporated by reference herein.

### BACKGROUND

### Technical Field

The present disclosure relates to an information processing apparatus, an image forming apparatus, an information processing method, and a non-transitory recording medium.

### Related Art

In recent advanced information society, the demand for security enhancement has increased. For example, high security is required for a system to be used by a large number of users, such as a multifunction peripheral (MFP) having a plurality of functions.

Multi-factor authentication has been proposed in that, when a user who uses the MFP (referred to as an “MFP user”) logs on, second authentication is performed by inputting a password on a screen of an operation device of the MFP, following first authentication by touching or swiping an integrated circuit (IC) card. In the multi-factor authentication, a technique has been proposed in which face authentication is added to prevent a malicious third party who knows a password for second authentication from impersonating the MFP user after first authentication by the MFP user is completed.

### SUMMARY

The present disclosure described herein provides an information processing apparatus including: a memory that stores user information of one or more users who are authorized to use a predetermined system, the user information including user identification information for identifying the user; and circuitry to monitor presence of a user who uses the predetermined system, authenticate the user based on the user information of the user, and reset authentication information of the user or an operation screen of the predetermined system, when the circuitry detects that the user has left the predetermined system beyond a predetermined range after authentication of the user and before the user completes a use of the predetermined system.

The present disclosure described herein provides an image forming apparatus including the information processing apparatus, and the predetermined system being an image forming system.

The present disclosure described herein provides an information processing method including: storing, in a memory, user information of one or more users who are authorized to use a predetermined system, the user information including user identification information for identifying the user; monitoring presence of a user who uses the predetermined system; authenticating the user based on the user information of the user; and resetting authentication information of the user or an operation screen of the predetermined system, when the monitoring detects that the user has left the predetermined system beyond a predetermined range after authentication of the user and before the user completes a use of the predetermined system.

The present disclosure described herein provides a non-transitory recording medium storing a plurality of instructions which, when executed by one or more processors, causes the one or more processors to perform a method, the information processing method including: storing, in a memory, user information of one or more users who are authorized to use a predetermined system, the user information including user identification information for identifying the user; monitoring presence of a user who uses the predetermined system; authenticating the user based on the user information of the user; and resetting authentication information of the user or an operation screen of the predetermined system, when the monitoring detects that the user has left the predetermined system beyond a predetermined range after authentication of the user and before the user completes a use of the predetermined system.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a diagram illustrating an example of a scene to which an information processing method according to an embodiment is applied;

FIG. 1B is a functional block diagram of an information processing apparatus that performs the information processing method illustrated in FIG. 1A;

FIG. 1C is a flowchart of an example operation performed by the information processing apparatus illustrated in FIG. 1B;

FIG. 2 is a block diagram illustrating an example of a hardware configuration of an image forming apparatus according to a first embodiment;

FIG. 3 is a block diagram illustrating an example of a software configuration of an image forming apparatus according to the first embodiment;

FIG. 4 is a functional block diagram of an image forming apparatus according to the first embodiment;

FIG. 5 is a diagram illustrating an example of user information;

FIG. 6 is an example of a flowchart of an operation of an information processing apparatus according to the first embodiment;

FIG. 7 is a flowchart of a subroutine of zeroth authentication illustrated in FIG. 6;

FIG. 8 is a flowchart of a subroutine of first authentication illustrated in FIG. 6;

FIG. 9 is a diagram illustrating an example of a display on an operation panel in a case where authentication is successful in FIG. 6;

FIG. 10 is a diagram illustrating an example of a display on an operation panel in a case where authentication fails in FIG. 6;

FIG. 11 is a diagram illustrating an example of a setting screen for zeroth authentication displayed by an information processing apparatus according to a second embodiment;

FIG. 12 is a flowchart of an example operation performed by the information processing apparatus according to the second embodiment;

FIG. 13 is a flowchart of an example operation performed by an information processing apparatus according to a third embodiment;

FIG. 14 is a diagram illustrating an example of a reset setting screen displayed by an information processing apparatus; and

FIG. 15 is a flowchart of an operation performed by an information processing apparatus according to a fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In the following embodiments, an example in which an information processing technique for enhancing security is applied to an image forming apparatus is described, but the present disclosure is not limited to this example. For example, the information processing method of the embodiments may be applied to other systems, devices, or apparatuses that require user authentication, such as a data management system.

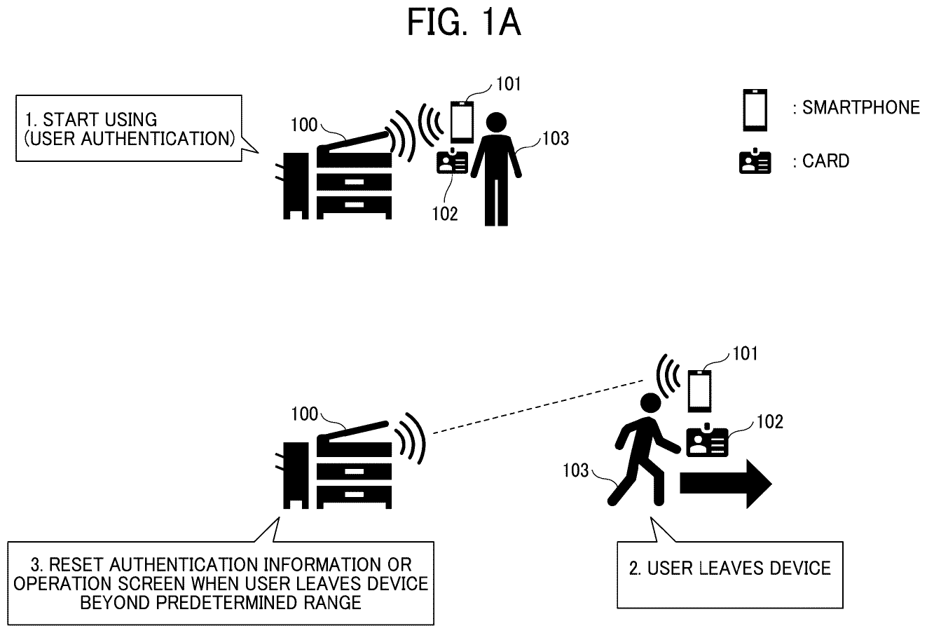

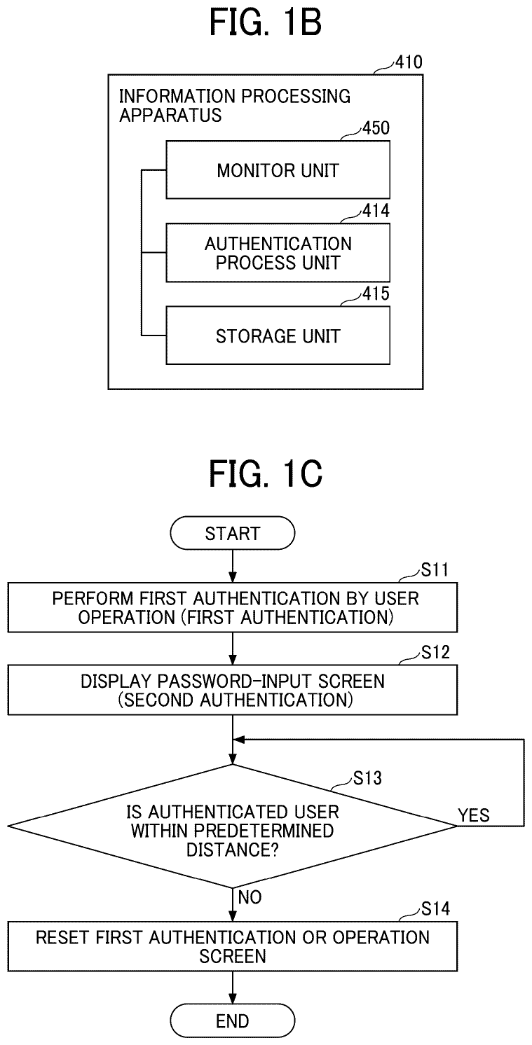

FIG. 1A is a diagram illustrating an example scene to which the information processing method according to an embodiment is applied. First, a user 103 approaches an image forming apparatus 100 with a card 102 that enables a use of the image forming apparatus 100, and performs user authentication. The authentication of the user 103 is performed by an information processing apparatus included in the image forming apparatus 100 or connected to the image forming apparatus 100. The user authentication includes, e.g., authentication by an operation using the card 102, and includes authentication of other factors as necessary. For example, when the user 103 has a short-distance wireless communication terminal 101 (in FIG. 1A, the smartphone), automatic authentication using a short-distance wireless communication function of the image forming apparatus 100 or the information processing apparatus may be included in the user authentication. The user authentication may also include the password input to a log on screen displayed on the image forming apparatus 100 after the user authentication by the operation using the card 102. As described above, the user authentication may be multi-factor authentication including a plurality of factors. In the following embodiments, automatic authentication by short-distance wireless communication may be referred to as zeroth authentication, and authentication by an operation of a user may be referred to as first authentication. However, zeroth authentication is not required and may be omitted depending on a use situation. The authentication using the card 102 is an example of first authentication. Alternatively, the first authentication may be authentication using biological information such as a fingerprint or a voiceprint. The card 102 and the short-distance wireless communication terminal 101 may be separate from each other. Alternatively, a short-distance wireless communication function may be included in the card 102, instead of providing the short-distance wireless communication terminal 101. In this disclosure, the zeroth authentication by the short-distance wireless communication and the user authentication using the short-distance wireless communication terminal 101 may be used interchangeably. The user 103 who uses the image forming apparatus 100 is identified by the user authentication. After the user 103 is identified, a log on screen or a menu screen may be displayed on an operation panel of the image forming apparatus 100.

When the user 103 has left the image forming apparatus 100 beyond a predetermined range after the user authentication and before the user 103 completes a use of the image forming apparatus 100, the authentication information of the user 103 or an operation screen of the image forming apparatus 100 is reset in the image forming apparatus 100. The information processing apparatus monitors whether the user 103 has left the image forming apparatus 100 beyond the predetermined range. For example, the information processing apparatus determines that the user 103 has left the image forming apparatus 100 beyond the predetermined range when the strength of radio waves from the short-distance wireless communication terminal 101 received by the image forming apparatus 100 is lower than a threshold value. Alternatively, the information processing apparatus may calculate the distance between the image forming apparatus 100 and the user 103 based on position information transmitted from the short-distance wireless communication terminal 101. Alternatively, the information processing apparatus may determine that the user 103 has left the image forming apparatus 100 beyond the predetermined range when there is no operation on the image forming apparatus 100 within a predetermined time after user authentication using a timer function of the image forming apparatus 100 or the information processing apparatus.

The short-distance wireless communication terminal 101 may be, e.g., a portable information processing terminal such as a smartphone or a smartwatch, or may be a radio frequency (RF) tag included in the card 102. The card 102 in the present specification may be referred to as an IC card.

When the user 103 holds the short-distance wireless communication terminal 101, the user 103 is assumed to hold the short-distance wireless communication terminal 101 even when the user 103 has left the image forming apparatus 100 after the user authentication.

When the user 103 has left the image forming apparatus after the user 103 who uses the image forming apparatus 100 is identified by the first authentication, the image forming apparatus 100 are assumed to have either one of the three following states.

The three states include:
(1) a state before a password is input to the log on screen;
(2) a state after a password has been input on the log on screen and before an operation is performed on the menu screen; and
(3) a state after an input has been performed on the menu screen and before the user completes a use of the image forming apparatus 100.

In each of the states (1) to (3) described above, the image forming apparatus 100 may be used by a malicious third party as follows.
(1): A third party who does not have the card 102 necessary for the first authentication of the user 103 but knows the password of the user 103 logs on to the image forming apparatus 100 by inputting the password of the user 103 to the log on screen and uses the image forming apparatus 100.
(2): A third party who does not have the card 102 necessary for the first authentication of the user 103 and does not know the password of the user 103 operates the menu screen after the log on without permission to use the image forming apparatus 100.
(3): A third party who does not have the card 102 necessary for the first authentication of the user 103 and does not know the password of the user 103 operates the image forming apparatus 100 during the operation of the image forming apparatus 100 based on the operation of the user.

These unauthorized uses can be prevented by invalidating the first authentication by the operation of the user 103 (first authentication) or resetting the operation screen when the user 103 has left the apparatus beyond a predetermined range as illustrated in FIG. 1A, thus enhancing the security of the image forming apparatus 100.

FIG. 1B is a block diagram of the information processing apparatus 410 that performs the process illustrated in FIG. 1A. FIG. 1C is a flowchart of an example operation performed by the information processing apparatus 410 illustrated in FIG. 1B. The information processing apparatus 410 is implemented by a processor such as a central processing unit (CPU) and a memory, and may be included in the image forming apparatus 100 or may be connected to the image forming apparatus 100 via, e.g., a network.

As illustrated in FIG. 1B, the information processing apparatus 410 that performs the process illustrated in FIG. 1A includes a monitor unit 450 that monitors whether the user 103 has left the device (in this example, the image forming apparatus 100) beyond a predetermined range, an authentication process unit 414 that performs user authentication based on user information including identification information for identifying the user 103, and a storage unit 415 that stores the user information. Specifically, the monitor unit 450 and the authentication processing unit 414 are implemented by the CPU, and the storage unit 415 is implemented by the memory. The specific example configurations of the information processing apparatus 410 will be described below.

As illustrated in FIG. 1C, in step S11, the authentication processing unit 414 performs first authentication by an operation of the user 103 (first authentication). In step S12, the authentication processing unit 414 performs authentication by password input (second authentication). After the second authentication is completed, in step S13, the monitor unit 450 monitors whether the user 103 who has completed the second authentication is within a predetermined range from the information processing apparatus 410. When the user 103 is not within the predetermined range, the authentication information of the user 103 (first authentication) or the operation screen of the information processing apparatus 410 is reset in the information processing apparatus 410. The above description is an application example of the information processing method.

The configuration of the image forming apparatus 100 is described below.

### Configuration Example of Image Forming Apparatus

### Hardware Configuration

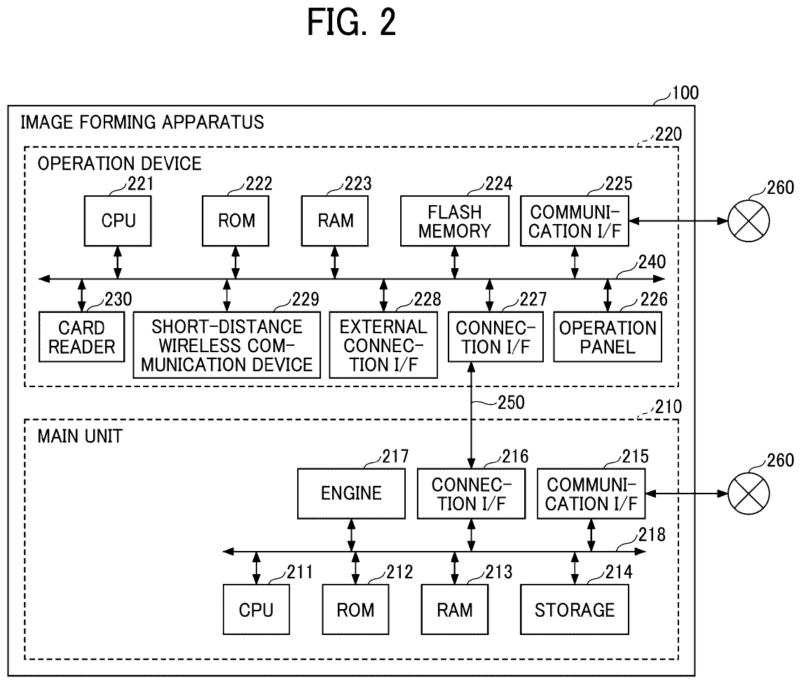

FIG. 2 is a block diagram illustrating an example of a hardware configuration of the image forming apparatus 100.

The image forming apparatus 100 includes a main unit 210 having image forming engines that implement various image forming functions such as a copy function, a scanner function, a facsimile (FAX) function, and a printer function, and an operation device 220 that receives a user operation on, e.g., each image forming engine and a controller. The reception of the operation of the user 103 is, for example, reception of information (including a signal indicating a coordinate value of a screen) input according to the operation of the user 103.

### Hardware Configuration of Main Unit

As illustrated in FIG. 2, the main unit 210 includes a central processing unit (CPU) 211, a read-only memory (ROM) 212, a random-access memory (RAM) 213, a storage 214, a communication interface (I/F) 215, a connection I/F 216, an engine 217, and a system bus 218.

The CPU 211 controls the entire operation of the main unit 210. The CPU 211 controls the entire operation of the main unit 210 by executing a program stored in, e.g., the RAM 213 or the storage 214 with the ROM 212 as a work area. For example, the CPU 211 implements various functions such as the copy function, the scanner function, the FAX function, and the printer function described above.

The ROM 212 is, e.g., a nonvolatile memory that stores a basic input/output system (BIOS), which is executed when the main unit 210 is started, and various settings. The RAM 213 is a volatile memory used as a work area for the CPU 211. The storage 214 is a nonvolatile storage device that stores, e.g., an operating system (OS), an application program, and various data. The storage 214 includes, e.g., a hard disk drive (HDD) and a solid state drive (SSD).

The communication I/F 215 is a network interface for connecting the main unit 210 to a network 260 and performing communication with an external apparatus connected to the network 260. The connection I/F 216 is an interface for communicating with the operation device 220 via a communication path 250.

The engine 217 is hardware that performs general-purpose processing for implementing the copy function, the scanner function, the FAX function, and the printer function, except for communication processing. The engine 217 includes, e.g., a scanner (image reading device) that scans and reads an image on a document, a plotter that prints an image on a sheet material such as paper, and a FAX device that performs FAX communication.

The engine 217 may further include optional equipment such as a finisher that sorts printed sheets, and an automatic document feeder (ADF) that automatically feeds documents to be scanned.

The system bus 218 is connected to the above-described components and transfers, e.g., address signals, data signals, and various control signals.

### Hardware Configuration of Operation Device

As illustrated in FIG. 2, the operation device 220 includes a CPU 221, a ROM 222, a RAM 223, a flash memory 224, a communication I/F 225, an operation panel 226, a connection I/F 227, an external connection I/F 228, a short-distance wireless communication device 229, a card reader 230, and a system bus 240.

The CPU 221 controls the entire operation of the operation device 220. The CPU 221 controls the entire operation of the operation device 220 by executing a program stored in, e.g., the ROM 222 or the flash memory 224 using the RAM 223 as a work area. For example, the CPU 221 implements various functions such as displaying information (image) according to an input received from the user 103 on the operation panel 226.

The ROM 222 is, e.g., a nonvolatile memory that stores a BIOS, which is executed when the operation device 220 is started, and various settings. The RAM 223 is a volatile memory used as a work area for the CPU 221. The flash memory 224 is a nonvolatile storage device that stores, e.g., an OS, an application program, and various data.

The communication I/F 225 is a network interface for connecting the operation device 220 to the network 260 and communicating with an external apparatus connected to the network 260.

The operation panel 226 is a device having an input function for receiving various inputs according to an operation of the user 103, and a display function displaying various information (e.g., information according to the received operation, information indicating an operation status of the image forming apparatus 100, setting information). Examples of the operation panel 226 include a liquid crystal display (LCD) having a touch panel function.

The operation panel 226 is not limited to the LCD, and may include, e.g., a display of an organic electro-luminescence (EL) implementing a touch panel function. In addition to or in alternative to the touch panel function, the operation panel 226 may be provided with an operation unit such as a hardware key or a display unit such as a lamp.

The connection I/F 227 is an interface for communicating with the main unit 210 via the communication path 250. The external connection I/F 228 is an interface such as a universal serial bus (USB) for connecting an external device.

The short-distance wireless communication device 229 is a short-distance wireless circuit that communicates with the short-distance wireless communication terminal 101 within a predetermined range by short-distance wireless communication. The short-distance wireless communication device 229 measures the radio wave strength from the short-distance wireless communication terminal 101 to the short-distance wireless communication device 229 to detect the short-distance wireless communication terminal 101 having a radio field strength exceeding a predetermined threshold value. The short-distance wireless communication device 229 may be a short-distance wireless device that performs short-distance wireless communication such as Bluetooth (Registered Trademark) low energy (BLE). The radio wave strength may be represented by a numerical value such as a received signal strength indicator (RSSI).

The card reader 230 is a device for reading identification information from the card 102 by short-distance wireless communication.

The system bus 240 is connected to the above-described components and transfers address signals, data signals, and various control signals.

### Software Configuration

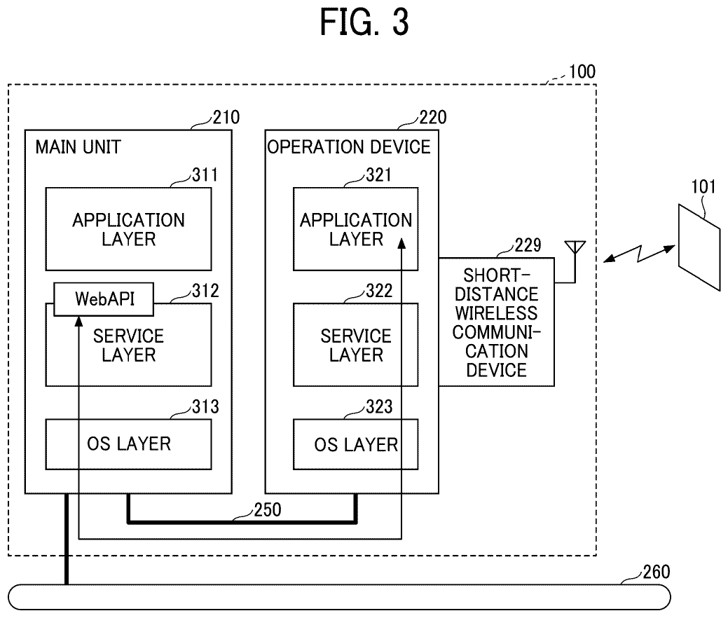

FIG. 3 is a block diagram illustrating an example of a software configuration of the image forming apparatus 100.

As illustrated in FIG. 3, the main unit 210 of the image forming apparatus 100 includes an application layer 311, a service layer 312, and an OS layer 313. The application layer 311, the service layer 312, and the OS layer 313 are various software stored in, e.g., the ROM 212 or the storage 214. Functions of the main unit 210 are implemented by the CPU 211 executing a predetermined program.

The application layer 311 is application software (hereinafter, simply referred to as an “application” in some cases) for operating hardware resources to provide a predetermined function. Examples of the application include a copy application for providing the copy function, a scanner application for providing the scanner function, a FAX application for providing the FAX function, and a printer application for providing the printer function.

The service layer 312 is software that is interposed between the application layer 311 and the OS layer 313 to provide an interface for using hardware resources included in the main unit 210 to the application of the application layer 311. Specifically, the service layer 312 provides a function of receiving an operation request for a hardware resource and arbitrating the operation request. The operation request received by the service layer 312 includes a request for reading by a scanner and a request for printing by a plotter. The interface function of the service layer 312 is provided not only to the application layer 311 of the main unit 210 but also to the application layer 321 of the operation device 220. The interface function of the Web API of the service layer 312 is provided by, e.g., the Web API. In other words, the application layer 321 of the operation device 220 also implements a function using the hardware resource (e.g., the engine 217) of the main unit 210 via the interface function of the Web API of the service layer 312 of the main unit 210.

The OS layer 313 is basic software (OS) for providing basic functions for controlling hardware included in the main unit 210. The service layer 312 converts a request for use of a hardware resource from various applications into a command interpretable by the OS layer 313 and passes the command to the OS layer 313. The OS layer 313 executes the command, and thus the hardware resource performs an operation according to the request of the application.

As illustrated in FIG. 3, the operation device 220 of the image forming apparatus 100 includes an application layer 321, a service layer 322, and an OS layer 323. The application layer 321, the service layer 322, and the OS layer 323 included in the operation device 220 also have the same hierarchical structure as that of the main unit 210. However, functions provided by an application of the application layer 321 and types of operation requests that are received by the service layer 322 are different from those of the main unit 210.

The application of the application layer 321 may be software for providing a predetermined function by operating hardware resources included in the operation device 220, but mainly provides a function of a user interface (UI) for performing an operation and display related to a function included in the main unit 210. The application of the application layer 321 provides the short-distance wireless communication device 229 included in the operation device 220.

In order to maintain the independence of the functions, the software of the OS layer 313 on the main unit 210 and the software of the OS layer 323 on the operation device 220 are different from each other. In other words, the main unit 210 and the operation device 220 operate independently of each other by different operating systems. For example, Linux (Registered Trademark) may be used as the software of the OS layer 313 on the main unit 210, and Android (Registered Trademark) may be used as the software of the OS layer 323 on the operation device 220.

As described above, in the image forming apparatus 100, the main unit 210 and the operation device 220 operate on different operating systems, and thus communication between the main unit 210 and the operation device 220 is performed as communication between different apparatuses, not inter-process communication in a common apparatus. Examples of the communication between the main unit 210 and the operation device 220 may include transmitting information (operation instruction content from the user) received by the operation device 220 to the main unit 210 (command communication) and transmitting information from the main unit 210 to the operation device 220. The command communication from the operation device 220 to the main unit 210 activates the functions of the main unit 210 to be used. The information transmitted from the main unit 210 to the operation device 220 includes, e.g., the execution status of the operation in the main unit 210 and the contents set on the main unit 210. Since the power is supplied to the operation device 220 from the main unit 210 via the communication path 250, the power control by the operation device 220 is performed separately (independently) from the power control by the main unit 210.

### Functional Configuration

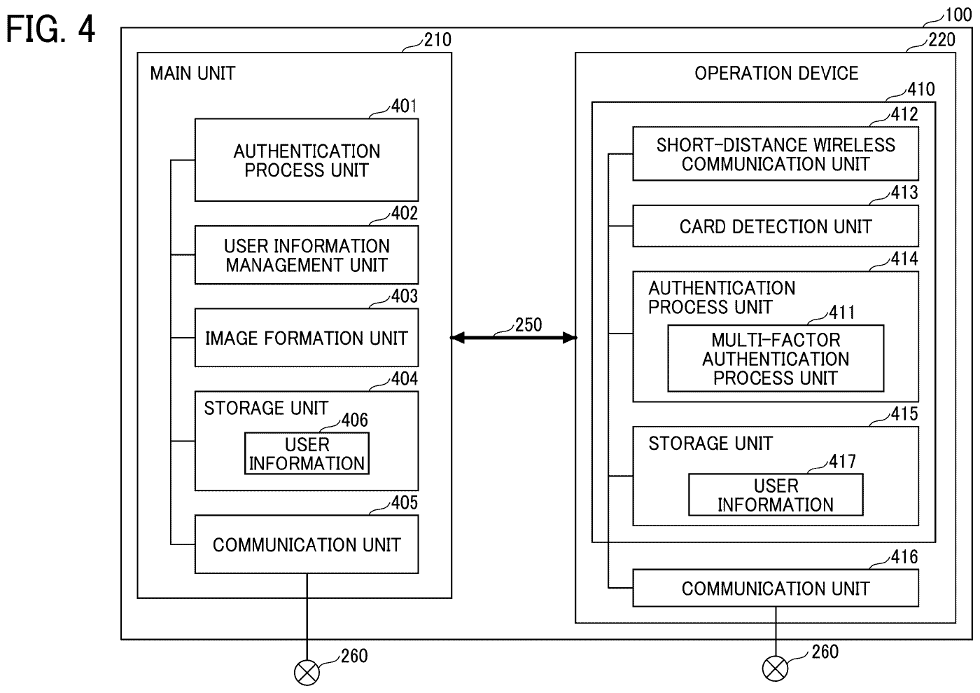

FIG. 4 is a functional block diagram of the image forming apparatus 100.

### Functional Configuration of Main Unit

As illustrated in FIG. 4, the main unit 210 of the image forming apparatus 100 includes an authentication process unit 401, a user information management unit 402, an image formation unit 403, a storage unit 404, and a communication unit 405.

The authentication process unit 401 is a functional unit that controls log on or log out processing to the image forming apparatus 100. The authentication process unit 401 is implemented by, e.g., a program that operates in the CPU 211 illustrated in FIG. 2.

The user information management unit 402 is a functional unit that manages the user information 406 stored in the storage unit 404. The user information management unit 402 is implemented by, e.g., a program that operates in the CPU 211 illustrated in FIG. 2.

The image formation unit 403 is a functional unit that executes various image forming functions (e.g., the printer function, the copy function, the scanner function, and the FAX function) included in the image forming apparatus 100. The image formation unit 403 is implemented by, e.g., the engine 217 illustrated in FIG. 2 and a program operating in the CPU 211 illustrated in FIG. 2.

The storage unit 404 is a functional unit that stores various information such as user information 406 including information identifying a user of the image forming apparatus 100 registered in advance. The storage unit 404 is implemented by, e.g., a program that operates in the CPU 211, the RAM 213, and the storage 214 illustrated in FIG. 2.

The communication unit 405 is a functional unit that connects the main unit 210 to the network 260 to communicate with an external apparatus connected to the network 260. The communication unit 405 is implemented by, e.g., a program that operates in the CPU 211 and the communication I/F 215 illustrated in FIG. 2.

The authentication process unit 401, the user information management unit 402, the image formation unit 403, the storage unit 404, and the communication unit 405 of the main unit 210 illustrated in FIG. 4 are conceptual representations of functions, and the present disclosure is not limited to such a configuration. For example, a plurality of functional units illustrated as independent functional units in the main unit 210 illustrated in FIG. 4 may be configured as one functional unit. On the other hand, the function of one functional unit in the main unit 210 illustrated in FIG. 4 may be divided into a plurality of functions to be configured as a plurality of functional units.

The image formation unit 403 of the main unit 210 may be implemented by a hardware circuit such as a field-programmable gate array (FPGA) or an application-specific integrated circuit (ASIC) instead of a program that is software.

### Functional Configuration of Operation Device

As illustrated in FIG. 4, the operation device 220 of the image forming apparatus 100 includes an information processing apparatus 410 and a communication unit 416. The information processing apparatus 410 includes a short-distance wireless communication unit 412, a card detection unit 413, an authentication process unit 414, and a storage unit 415. The authentication process unit 414 includes a multi-factor authentication process unit 411. The storage unit 415 includes user information 417. The information processing apparatus 410 is implemented by the CPU 221, the ROM 222, and the RAM 223 in FIG. 2. The information processing apparatus 410 is included in the operation device 220 of the image forming apparatus 100, but may be externally attached to the image forming apparatus 100 or may be connected to the image forming apparatus 100 via, e.g., a network. When the information processing apparatus 410 is included in the image forming apparatus 100 as illustrated in FIG. 4, the monitor unit 450 illustrated in FIG. 1B may be implemented by the short-distance wireless communication unit 412.

The multi-factor authentication process unit 411 is a functional unit that displays a screen for receiving settings for executing multi-factor authentication and log on. The multi-factor authentication process unit 411 is implemented by, e.g., the CPU 211 illustrated in FIG. 2 or a program executed by the CPU 211.

The short-distance wireless communication unit 412 is a functional unit that detects radio waves of short-distance wireless communication of, e.g., the short-distance wireless communication terminal 101. The short-distance wireless communication unit 412 is implemented by, e.g., the short-distance wireless communication device 229 illustrated in FIG. 2 and the CPU 221 illustrated in FIG. 2.

The card detection unit 413 detects information included in the card 102 held by the user 103, and notifies the multi-factor authentication process unit 411 of the detected card information. The card detection unit 413 is implemented by, e.g., the card reader 230 and the CPU 221 illustrated in FIG. 2.

The authentication process unit 414 including the multi-factor authentication process unit 411 manages the user information 417 stored in the storage unit 415 to perform cooperation between the multi-factor authentication process unit 411 and the authentication process unit 401 of the main unit 210. The authentication process unit 414 is implemented by, e.g., the CPU 221 illustrated in FIG. 2 or a program executed by the CPU 221.

The storage unit 415 is a functional unit that stores card-association information and short-distance wireless communication information as the user information 417 of the operation device 220 in addition to the user information 406 of the main unit 210. The storage unit 415 is implemented by, e.g., the RAM 213 illustrated in FIG. 2, the flash memory 224, and a program that operates in the CPU 211 illustrated in FIG. 2.

The communication unit 416 is a functional unit that connects the operation device 220 to the network 260 to communicate with an external apparatus connected to the network 260. The communication unit 416 is implemented by, e.g., the communication I/F 225 illustrated in FIG. 2 and a program that operates in the CPU 211 illustrated in FIG. 2.

The multi-factor authentication process unit 411, the short-distance wireless communication unit 412, the card detection unit 413, the authentication process unit 414, the storage unit 415, and the communication unit 416 of the operation device 220 illustrated in

FIG. 4 are conceptual representations of functions, and the present disclosure is not limited to such a configuration. For example, a plurality of functional units illustrated as independent functional units in the operation device 220 illustrated in FIG. 4 may be configured as one functional unit. On the other hand, the functions of one functional unit in the operation device 220 illustrated in FIG. 4 may be divided into a plurality of functions to be configured as a plurality of functional units.

Some or all of the authentication process unit 414 including the multi-factor authentication process unit 411, the short-distance wireless communication unit 412, and the card detection unit 413 of the operation device 220 may be implemented by a hardware circuit such as an FPGA or an ASIC, instead of a program that is software.

At least a part of the functions of the operation device 220 may be executed in the main unit 210, and conversely, at least a part of the functions of the main unit 210 may be executed in the operation device 220.

### Configuration of User Information

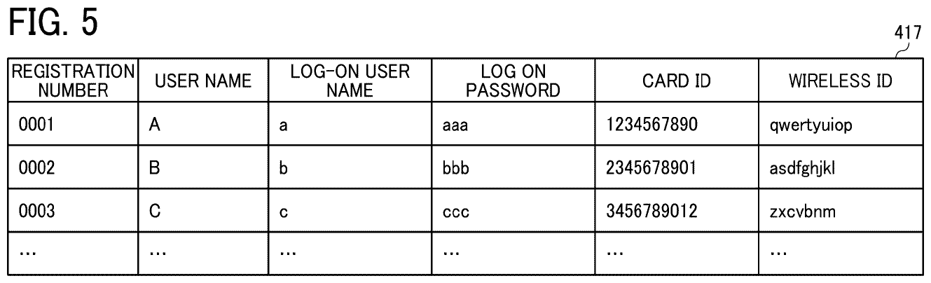

FIG. 5 is a diagram illustrating an example of user information.

The user information 417 illustrated in FIG. 5 is an example of user information registered in advance. In the example illustrated in FIG. 5, the user information 417 includes information such as a “registration number,” a “user name,” a “log-on user name,” a “log on password,” a “card ID (Identity),” and a “wireless ID.”

The “registration number” is, e.g., a serial number assigned to each user when information of the user is registered in the user information 417, or an identification number unique to each data of the user, and is an example of identification information unique to each user (identification information identifying the user). The “registration number” may be any identification information identifying the user, such as an employee ID of the user.

The “user name” is a name of the user. The “log-on user name” and the “log on password” are examples of authentication information for the user to log on to the image forming apparatus 100.

The “card ID” is identification information of the card 102 held by each user. In a case where the biological information is used for authentication, the biological information of the user may be stored. The “wireless ID” is identification information of the short-distance wireless communication terminal 101 held by each user.

The user information 417 may include “mail address,” “FAX number,” and “authority information (for using the image forming apparatus 100)” in addition to the above-described information.

In the user information 417 illustrated in FIG. 5, e.g., a user having a registration number “0001” has a user name “A,” a log-on user name “a,” a log on password “aaa,” a card ID “1234567890,” and a wireless ID “qwertyuiop,” and these pieces of information are stored in association with each other.

The user information 417 illustrated in FIG. 5 is information in a table format, but is not limited thereto, and may be information in any format as long as the values of the respective fields are managed in association with each other.

### Flow of Authentication Process

A flow of authentication processing performed by the information processing apparatus 410 is described.

### First Embodiment

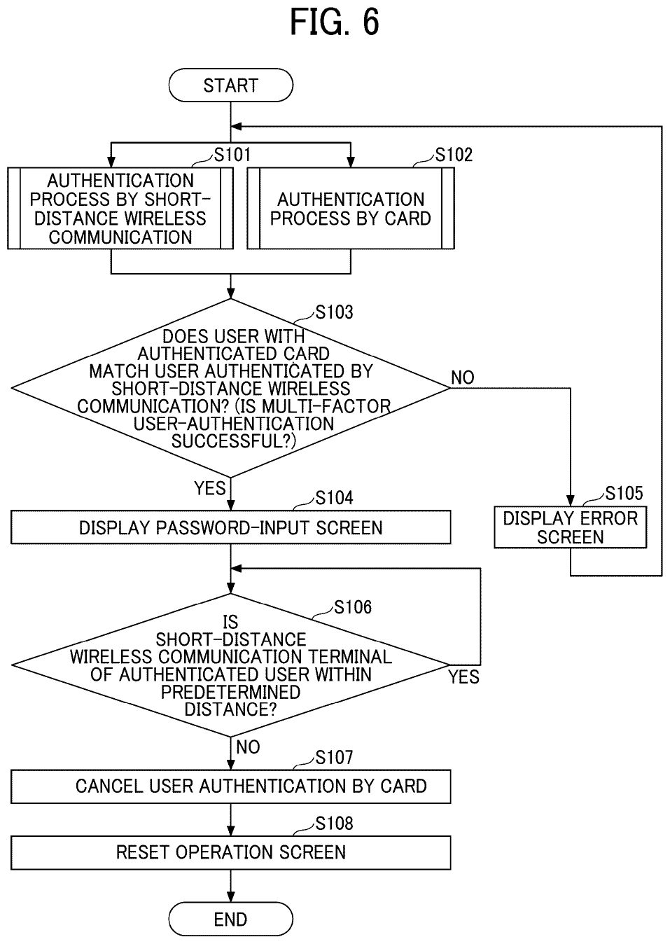

FIG. 6 is a flowchart of an operation of the information processing apparatus 410 according to the first embodiment. In the first embodiment, the information processing apparatus 410 performs multi-factor authentication in which zeroth authentication, first authentication, and authentication by password input are combined.

First, the authentication process unit 414 performs the processing of the zeroth authentication at step S101 and the processing of the first authentication at step S102 in parallel or sequentially.

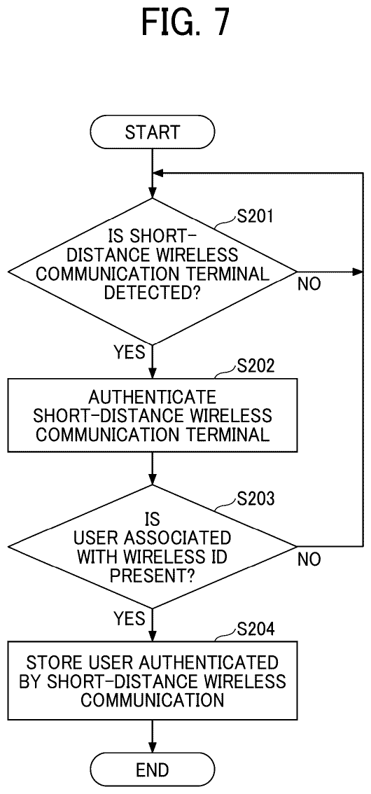

FIG. 7 is a flowchart of a subroutine of the zeroth authentication at step S101. For the sake of description, a case where BLE is used for short-distance wireless communication is described. As a basic communication flow of BLE, a case where the image forming apparatus 100 is a central serving as a master station and the short-distance wireless communication terminal 101 is a peripheral serving as a slave station is described. The device serving as a peripheral of BLE communication is not limited to the short-distance wireless communication terminal 101, and may be a wireless tag such as a radio frequency ID (RFID).

In step S201, the short-distance wireless communication unit 412 in the operation device 220 of the image forming apparatus 100 performs polling to detect the short-distance wireless communication terminal 101 by basic communication of BLE in order to detect the short-distance wireless communication terminal 101.

Specifically, the image forming apparatus 100, which is a central, waits for connection from the short-distance wireless communication terminal 101, which is a peripheral (advertise). When the short-distance wireless communication unit 412 detects the short-distance wireless communication terminal 101 (Yes at step S201), the process proceeds to step S202. On the other hand, when the short-distance wireless communication unit 412 does not detect the short-distance wireless communication terminal 101 (No at step S201), the short-distance wireless communication unit 412 performs detection again.

In step S202, the short-distance wireless communication unit 412 outputs the detected wireless ID of the short-distance wireless communication terminal 101 to the authentication process unit 414 to perform authentication processing of the short-distance wireless communication terminal 101.

Specifically, the authentication process unit 414 acquires the user information 417 and checks whether the user associated with the detected wireless ID of the short-distance wireless communication terminal 101 is present in the user information 417. When the authentication process unit 414 verified that the user associated with the wireless ID of the detected short-distance wireless communication terminal 101 is present in the user information 417, the authentication process unit 414 enables authentication of the detected short-distance wireless communication terminal 101. On the other hand, when the authentication process unit 414 did not verify that the user associated with the wireless ID of the detected short-distance wireless communication terminal 101 is present in the user information 417, the authentication process unit 414 disables the authentication of the detected short-distance wireless communication terminal 101.

In step S203, when the authentication process unit 414 enables the authentication of the detected short-distance wireless communication terminal 101 (when user information associated with the wireless ID is present) (Yes at step S203), the process proceeds to step

S204. On the other hand, when the authentication process unit 414 disables the authentication of the detected short-distance wireless communication terminal 101 (when user information associated with the wireless ID is not present) (No at step S203), the process returns to step S201, and the same process is repeated.

In step S204, the authentication process unit 414 stores, in a storage area of the storage unit 415, the user information associated with the detected wireless ID of the short-distance wireless communication terminal 101. The operation then ends.

Through the operations of steps S201 to S204 described above, the authentication process by the short-distance wireless communication, which is the zeroth authentication that does not require the operation by the user, is performed.

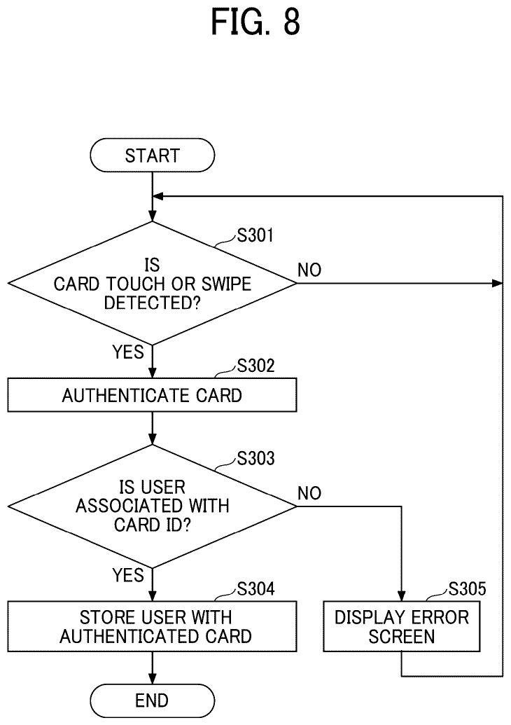

FIG. 8 is a flowchart of a subroutine of the first authentication in step S102.

In step S301, the card detection unit 413 in the operation device 220 of the image forming apparatus 100 polls to detect the card 102, and determines whether the card 102 is touched or swiped. When the card detection unit 413 detects the card 102 (Yes at step S301), the process proceeds to step S302. If the card detection unit 413 does not detect the card 102 (No at step S301), the card detection unit 413 performs detection again.

In step S302, the card detection unit 413 outputs the detected card ID of the card 102 to the authentication process unit 414 to perform authentication processing of the card 102.

Specifically, the authentication process unit 414 acquires the user information 417 and checks whether the user associated with the card ID of the detected card 102 is present in the user information 417. When the user associated with the card ID of the detected card 102 is verified to be in the user information 417, the authentication process unit 414 enables authentication of the detected card 102. On the other hand, when the authentication process unit 414 did not verify that the user associated with the card ID of the detected card 102 is in the user information 417, the authentication process unit 414 disables the authentication of the detected card 102.

In step S303, when the authentication of the detected card 102 is enabled as a result of the authentication by the authentication process unit 414 (when the user is associated with the card ID) (Yes at step S303), the process proceeds to step S304. On the other hand, when the authentication of the detected card 102 is disabled (when the user is not associated with the card ID) (No at step S303), the process proceeds to step S305.

In step S304, the authentication process unit 414 stores, in a memory, the user information associated with the card ID of the detected card 102. On the other hand, in step S305, the operation device 220 displays an error screen, and when the user closes the error screen, the process returns to step S301.

Through the operations of steps S301 to S305 described above, the authentication process by the card 102, which is the first authentication requiring the operation by the user, is performed.

Returning to FIG. 6, in step S103, the authentication process unit 414 determines whether the user 103 for whom the zeroth authentication has succeeded in step S101 and the user 103 for whom the first authentication has succeeded in step S102 are the same user. In other words, the authentication process unit 414 determines whether the user authentication, which is multi-factor authentication, has succeeded. As a result of the determination, when the user authentication is successful (Yes at step S103), the process proceeds to step S104.

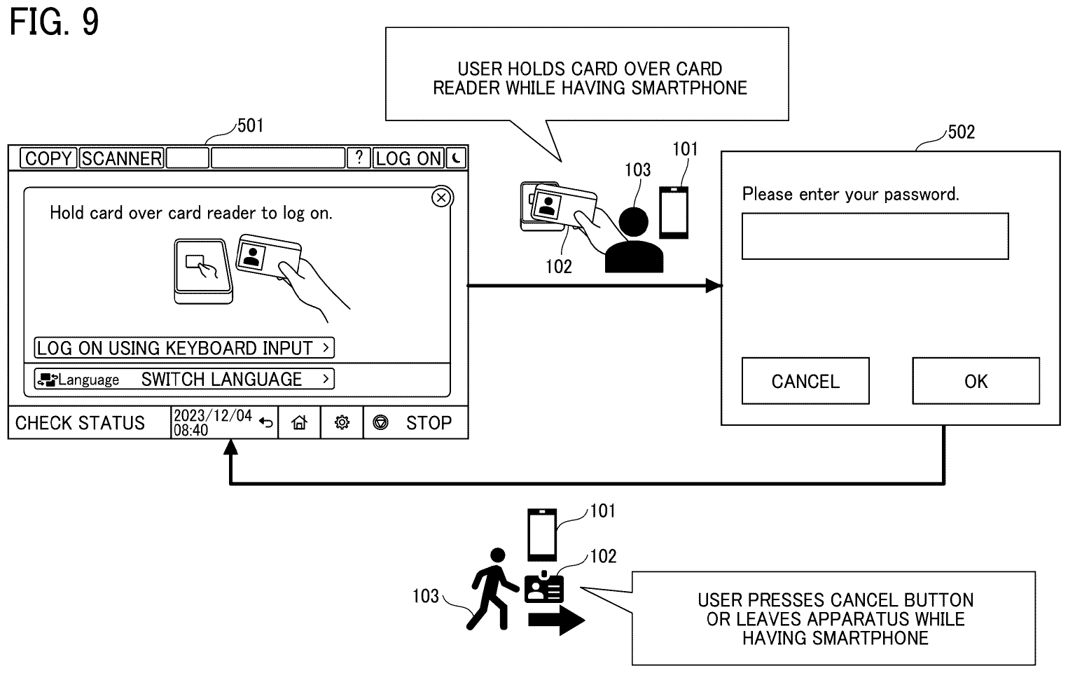

FIG. 9 illustrates an example of a display on the operation panel 226 when the determination in step S103 illustrated in FIG. 6 is Yes. When the user authentication is successful, in step S104, the authentication process unit 414 displays a password-input screen 502 on the operation panel 226 to perform authentication by password input. When the user 103 presses the cancel button or when the user 103 has left the apparatus, the authentication process unit 414 resets the user authentication information or the operation screen. For example, the authentication processing unit 414 deletes the user information (for example, the authentication information of the user) stored at S204 or S304, or stops displaying the operation screen such as the password-input screen 502.

On the other hand, when the user authentication is not successful (No at step S103), the process proceeds to step S105, and the error screen 503 is displayed. When the error screen 503 is closed, the process returns to steps S101 and S102.

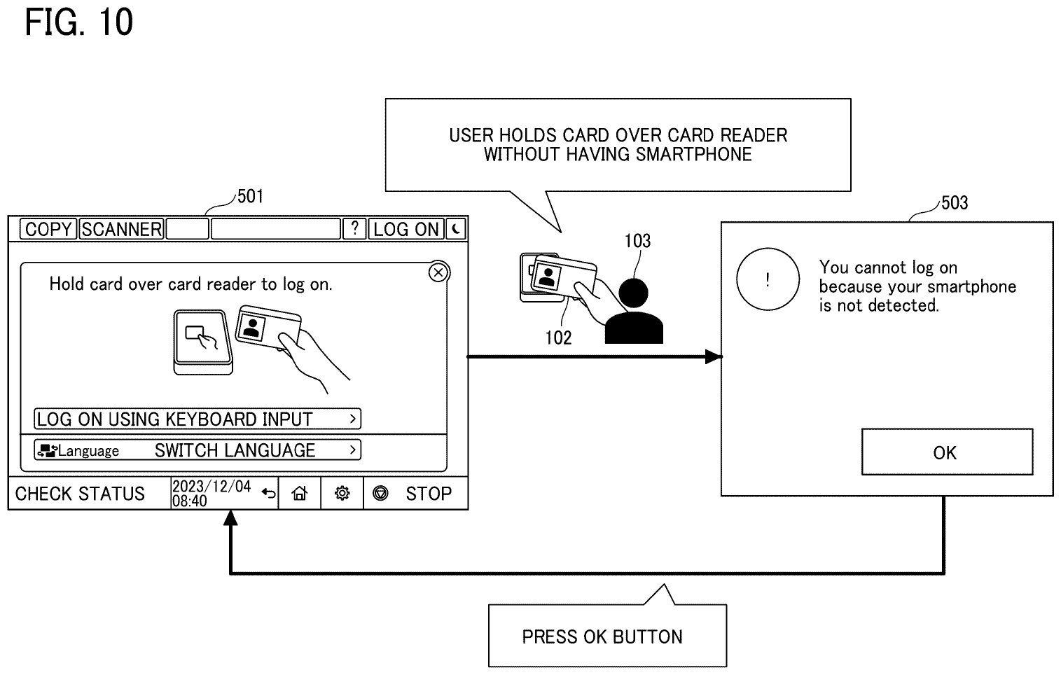

FIG. 10 illustrates an example of a display on the operation panel 226 when the determination in step S103 illustrated in FIG. 6 is No. Since the user authentication is not successful, the authentication process unit 414 displays the error screen 503 on the operation panel 226 in step S105. When the user 103 presses the OK button to close the error screen 503, the authentication process unit 414 resets the operation screen.

In step S106, the radio wave strength between the short-distance wireless communication terminal 101 held by the user 103 and the short-distance wireless communication device 229 is measured by short-distance wireless communication by the short-distance wireless communication unit 412 even while the password-input screen 502 is being displayed. In other words, the short-distance wireless communication unit 412 continues to detect whether the short-distance wireless communication terminal 101 held by the user 103 is within a predetermined distance. While the short-distance wireless communication unit 412 is detecting the short-distance wireless communication terminal 101 (Yes at S106), the authentication process unit 414 continues to display the password-input screen 502 on the operation panel 226.

When the user 103 inputs a password, the authentication process unit 414 compares the input password with the authentication information of the user who has succeeded in the previous authentication at S101 and S102, by referring to the user information 417. When the matching is successful, the user is allowed to log on to the image forming apparatus 100. On the other hand, when the matching fails, an error screen is displayed. As described above, while the short-distance wireless communication unit 412 is detecting the short-distance wireless communication terminal 101, the password-input screen 502 is continuously displayed on the operation panel 226.

When the short-distance wireless communication unit 412 does not detect that the short-distance wireless communication terminal 101 held by the user 103 is within the predetermined range in step S106 (No), the authentication process unit 414 deletes the user information on the user who has succeeded in the previous user authentication from the storage area. Accordingly, the image forming apparatus 100 returns to the state before the authentication processes in step S101 and step S102 are performed.

In step S108, the authentication process unit 414 stops displaying the password-input screen 502 on the operation panel 226 and displays an initial log-on screen 501.

As described above, with the information processing apparatus 410 of the first embodiment, the strength of security for a predetermined system (e.g., the image forming apparatus 100) having multi-factor authentication and the convenience of the user can be enhanced without additional cost by using the short-distance wireless communication terminal 101 held by the user.

In FIGS. 6, S101 and S102 may be performed subsequently. Further, only one of S107 and S108 may be performed.

### Second Embodiment

In a second embodiment, authentication by short-distance wireless communication is selectable. In the first embodiment, an example is described in which authentication by the short-distance wireless communication terminal 101 is performed as the zeroth authentication, authentication by the card 102 is performed as the first authentication, and authentication by password input is performed as the second authentication. In the second embodiment, settings related to zeroth authentication by the short-distance wireless communication terminal 101 can be changed.

When the user 103 who logs on to the image forming apparatus 100 touches or swipes the card 102 on the card reader 230 to perform the first authentication while the user 103 does not have the short-distance wireless communication terminal 101, the error screen 503 is displayed on the operation screen in the first embodiment, and the image forming apparatus 100 is disabled. In the second embodiment, whether to perform the zeroth authentication by the short-distance wireless communication terminal 101 is selectable, thereby enhancing the convenience for the user.

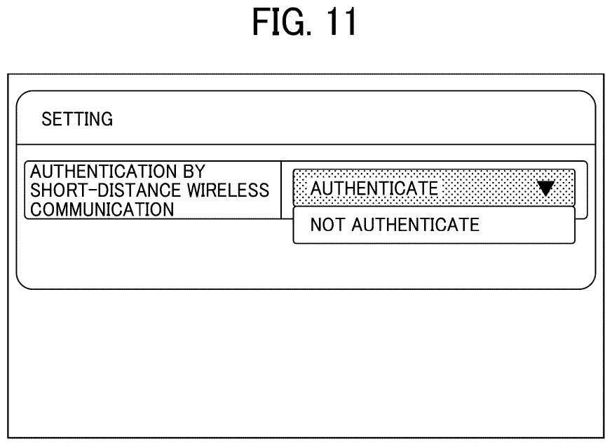

FIG. 11 is a diagram illustrating an example of a setting screen for the zeroth authentication displayed on the operation panel 226. The setting screen illustrated in FIG. 11 is displayed on the operation panel 226 by the authentication process unit 414, e.g., after or during the first authentication using the card 102. The user 103 may select whether to perform the zeroth authentication on the setting screen. When the user desires to cause the image forming apparatus 100 to perform the zeroth authentication by the short-distance wireless communication, the user 103 selects “Authenticate.” On the other hand, when the user desires to cause the image forming apparatus 100 not to perform the zeroth authentication, the user 103 selects “Not authenticate.”

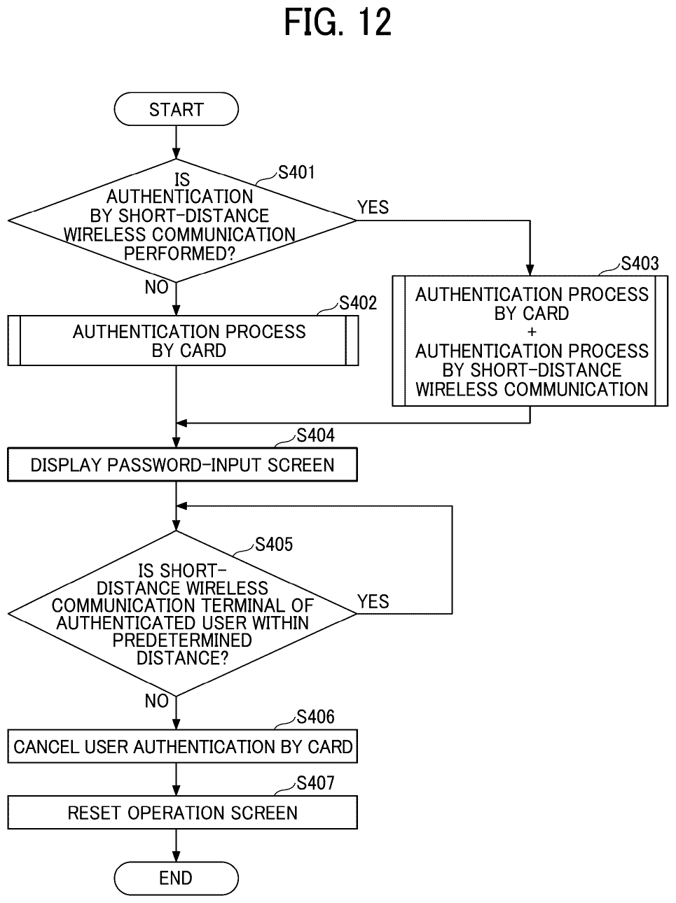

FIG. 12 is an example of a flowchart of an operation by the authentication process unit 414 of the information processing apparatus 410 according to the second embodiment. In step S401, the authentication processing unit 414 checks the setting to determine whether to perform the zeroth authentication in the image forming apparatus 100. When the zeroth authentication is to be performed (Yes at step S401), the process proceeds to step S403, and the first authentication using the card 102 and the zeroth authentication by the short-distance wireless communication are performed. When the first authentication is not to be performed (No at step S401), the process proceeds to step S402, and the first authentication using the card 102 is performed.

In step S403, when the image forming apparatus 100 performs the zeroth authentication, step S404 and the subsequent steps are performed in a substantially similar manner as described above referring to steps S104 to S108 illustrated in FIG. 6. On the other hand, when the zeroth authentication is not performed, the image forming apparatus 100 does not perform the zeroth authentication and performs only the first authentication by the card 102 in step S402, and then proceeds to step S404 to display the password-input screen 502.

The process of step S404 and the subsequent steps are performed in a substantially similar manner as described above referring to step S104 and the subsequent steps illustrated in FIG. 6. In step S404, the password-input screen 502 is displayed, and at the same time as or before or after step S404, in S405, it is determined whether the short-distance wireless communication terminal 101 of the user 103 is within a predetermined range from the image forming apparatus 100. When it is determined that the short-distance wireless communication terminal 101 of the user 103 is not within the predetermined range from the image forming apparatus 100 (No at step S405), in step S406, the first authentication using the card 102 is canceled, and in step S407, the password-input screen 502 is reset. In step S402, the first authentication is not performed, but the short-distance wireless communication unit 412 may measure the radio wave strength between the image forming apparatus 100 and the short-distance wireless communication terminal 101 held by the user who has succeeded in the first authentication. In other words, the short-distance wireless communication unit 412 may continue to detect whether the short-distance wireless communication terminal 101 held by the user 103 is within a predetermined distance, regardless of whether the zeroth authentication is performed. When the multi-factor authentication process unit 411 detects that the user who has succeeded in the first authentication has left the image forming apparatus 100 (No at step S405), in step S406, the multi-factor authentication process unit 411 deletes the user information on the user who has succeeded in the first authentication from the memory. Accordingly, the image forming apparatus 100 returns the state before the process of step S401 is performed.

In step S407, the authentication process unit 414 stops displaying the password-input screen 502 on the operation panel 226 and displays the initial log-on screen 501. In a case where the user 103 does not hold the short-distance wireless communication terminal 101, the user 103 may not be enabled to use the image forming apparatus 100 depending on the determination of step S405, even when the setting that the zeroth authentication is not performed is selected. Accordingly, when the setting is made such that the zeroth authentication is not performed (No at step S401), the authentication process unit 414 may perform the determination of step S405 using, e.g., a timer function provided for the CPU 221. For example, when no input operation to the password-input screen 502 is performed within a predetermined time from step S404 of displaying the password-input screen 502, it may be determined that the user 103 has left the image forming apparatus 100 beyond a predetermined range.

As described above, according to the configuration and method of the second embodiment, since the execution of the zeroth authentication is selectable, the flexibility in setting related to the user authentication is enhanced, and the convenience for the user is improved. Further, by using the short-distance wireless communication terminal 101 held by the user, the strength of security for the image forming apparatus 100 having the multi-factor authentication is enhanced without additional cost.

### Third Embodiment

In the first and second embodiments, when the first authentication using the short-distance wireless communication terminal 101 is performed, the short-distance wireless communication terminal 101 and the user 103 are associated with each other in advance (see FIG. 5). A third embodiment provides a configuration for enhancing the strength of security for a predetermined system such as the image forming apparatus 100 even when the short-distance wireless communication terminal 101 and the user 103 are not associated with each other in advance.

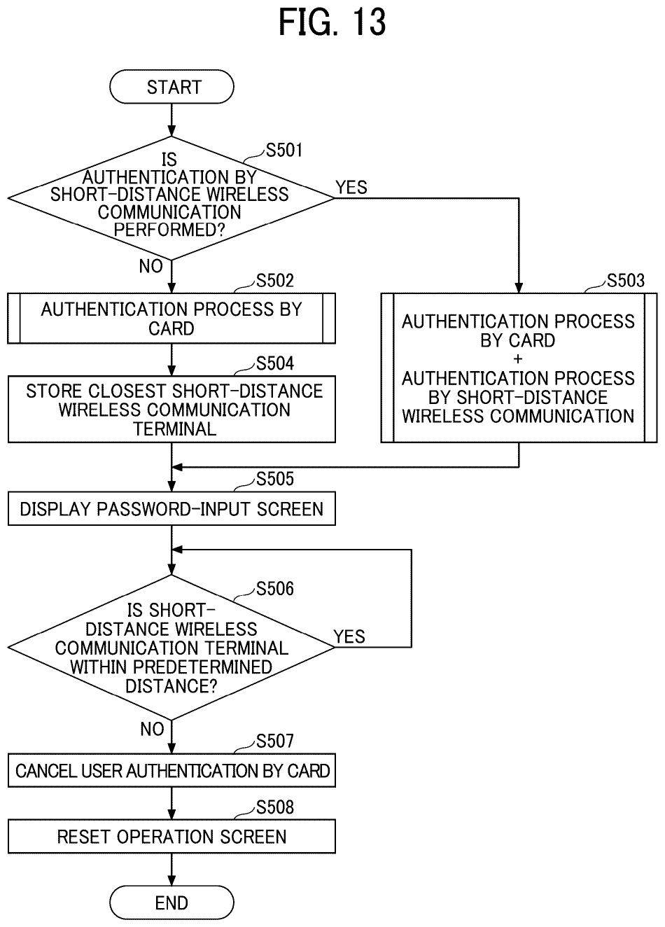

FIG. 13 is an example of a flowchart of an operation by the authentication process unit 414 of the information processing apparatus 410 according to the third embodiment. The third embodiment is based on the premise that the user 103 who uses the image forming apparatus 100 holds the short-distance wireless communication terminal 101. First, in step

S501, the image forming apparatus 100 checks the setting indicating whether to perform the zeroth authentication, in a similar manner as described in FIG. 12. When the zeroth authentication is to be performed (Yes at step S501), the process proceeds to step S503. When the zeroth authentication is not to be performed (No at step S501), the process proceeds to step S502.

In step S503, the image forming apparatus 100 performs the zeroth authentication, and thus the subsequent steps are the same as steps S104 to S108 illustrated in FIG. 6. On the other hand, in step S502, the image forming apparatus 100 does not perform the zeroth authentication, but performs only the first authentication by the card 102, and then the process proceeds to step S504.

In step S504, the authentication process unit 414 stores identification information of a terminal that is closest to the short-distance wireless communication device 229 when the first authentication is successful, as the short-distance wireless communication terminal 101 of the user for which the user authentication is being executed, and the process proceeds to step S505. The short-distance wireless communication terminal 101 to be stored may be the short-distance wireless communication terminal 101 having the strongest radio waves received by the short-distance wireless communication device 229.

The process of step S505 and the subsequent steps are performed in a substantially similar manner as described for the process of step S104 and the subsequent steps illustrated in FIG. 6, and thus the detailed description thereof is omitted. Even when the user 103 and the short-distance wireless communication terminal 101 are not associated with each other in advance, in step S506, the same process as step S106 illustrated in FIG. 6 and step S405 illustrated in FIG. 12 is performed. In other words, when it is detected that the user 103 who has succeeded in the first authentication has left the image forming apparatus 100 through the short-distance wireless communication by the short-distance wireless communication unit 412, the authentication process unit 414 deletes the user information on the user who has succeeded in the first authentication from the memory, so that the image forming apparatus 100 returns the state before the process of step S501.

In step S508, the authentication process unit 414 stops displaying the password-input screen 502 on the operation panel 226, and displays the initial log-on screen 501.

As described above, according to the configuration and method of the third embodiment, associating the short-distance wireless communication terminal 101 with the user 103 in advance is omitted, and the time and effort for the association work is saved. Further, the strength of security of user authentication increases while saving the time and effort of the association work.

### Fourth Embodiment

In the first to third embodiments, when the short-distance wireless communication unit 412 detects that the user who has succeeded in the first authentication has left the image forming apparatus 100, the authentication process unit 414 resets the operation panel 226 to the state before the zeroth authentication or the first authentication processing is performed, and the operation panel 226 is reset to the initial log-on screen 501. Considering a user who finds these resetting operations cumbersome, a fourth embodiment is provided to enable selection between resetting the authentication result and resetting the operation screen.

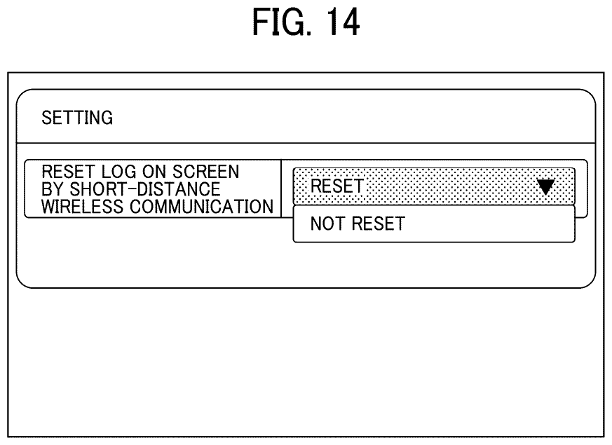

FIG. 14 illustrates an example of displaying a reset setting screen on the operation panel 226 in the fourth embodiment. When the user desires to cause the image forming apparatus 100 to change (reset) the log on screen on the operation panel 226 for the user operating the zeroth authentication or the first authentication by the short-distance wireless communication terminal 101 to the initial log-on screen 501, the setting of the above-described setting screen is set to “reset.” On the other hand, when the user desires to cause the image forming apparatus 100 not to change (reset) the log on screen on the operation panel 226 for the user operating the zeroth authentication or the first authentication by the short-distance wireless communication to the initial log-on screen 501, the setting of the above-described setting screen is set to “not reset.”

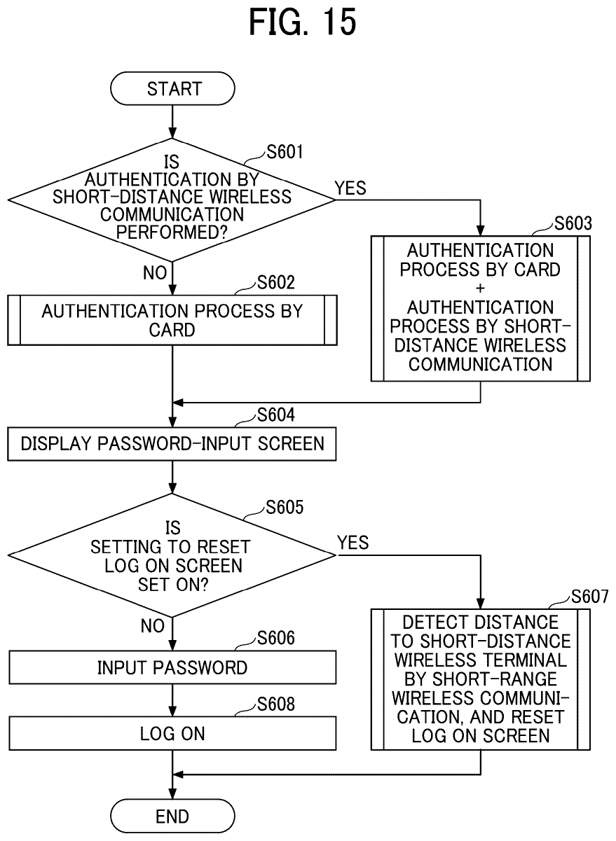

FIG. 15 is an example of a flowchart of an operation of the authentication process unit 414 of the information processing apparatus 410 according to the fourth embodiment. Steps S601 to S604 are the same as steps S401 to S404 illustrated in FIG. 12, and thus the description thereof is omitted.

In step S605, the image forming apparatus 100 checks the setting as to whether the setting for resetting the log on screen on the operation panel 226 to the initial log-on screen 501 is selected. When the setting indicates that the operation panel 226 is to be reset to the initial log-on screen 501 (Yes at step S605), the process proceeds to step S607. When the setting indicates that the operation panel 226 is not to be reset to the initial log-on screen 501 (No at step S605), the process proceeds to step S606.

In step S607, the image forming apparatus 100 performs the same operation as in steps S106 to S108 illustrated in FIG. 6 and steps S405 to S407 illustrated in FIG. 12 in order to reset the log on screen on the operation panel 226 to the initial log-on screen 501. On the other hand, in step S606, the log on screen on the operation panel 226 is not reset to the initial log-on screen 501, and therefore, the operation panel 226 continues to output the password-input screen 502 until the user 103 inputs the password.

In step S606, the user 103 inputs a correct password to log on to the image forming apparatus 100 in step S608.

As described above, according to the configuration and method of the fourth embodiment, the execution of resetting the log on screen by the short-distance wireless communication can be selected, and thus the flexibility in setting related to the user authentication is enhanced, and the convenience for the user is enhanced.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above. The embodiments described above can be combined with each other. For example, after the zeroth authentication by the short-distance wireless communication is selected in the second embodiment, a terminal device having the strongest reception strength may be stored as the short-distance wireless communication terminal for the user who is being authenticated as in the third embodiment. Alternatively, the displaying the reset setting screen in the fourth embodiment may be combined with each of the first to third embodiments or a combination thereof.

Some aspects of the present disclosure are described below.

### Aspect 1

An information processing apparatus includes a storage unit, a monitor unit, and an authentication process unit. The storage unit stores user information including identification information for identifying a user who uses a predetermined system. The monitor unit monitors presence of the user who uses the predetermined system. The authentication process unit authenticates the user based on the user information. When the monitor unit detects that the user has left the predetermined system beyond a predetermined range after user authentication and before the user completes a use of the predetermined system, the authentication process unit resets authentication information of the user or an operation screen of the predetermined system.

### Aspect 2

In the information processing apparatus according to Aspect 1, the storage unit stores card information of a card that enables the user to use the predetermined system or biological information of the user as the identification information. After first authentication based on the identification information, the authentication process unit causes an input screen for second authentication by inputting a password of the user to be displayed on the operation screen, and resets the first authentication and the input screen when the monitor unit detects that the user has left the predetermined system beyond the predetermined range after the input screen is displayed.

### Aspect 3

In the information processing apparatus according to Aspect 1 or 2, the storage unit stores terminal information of a short-distance wireless communication terminal of the user as the user information. The monitor unit is a short-distance wireless communication unit that performs short-distance wireless communication with the short-distance wireless communication terminal. The authentication process unit resets the authentication information of the user and the operation screen when strength of radio wave from the short-distance wireless communication terminal received by the short-distance wireless communication unit becomes smaller than a threshold value.

### Aspect 4

In the information processing apparatus according to Aspect 2 or 3, the storage unit stores the terminal information and the card information that enables the user to use the predetermined system as the user information. The authentication process unit causes the operation screen to display an error screen when the first authentication based on the card information and the second authentication based on the terminal information do not match.

### Aspect 5

In the information processing apparatus according to Aspect 2 or 4, the authentication process unit causes the operation screen to display a setting screen for switching whether to perform the second authentication based on the terminal information.

### Aspect 6

In the information processing apparatus according to Aspect 3 or 5, when the second authentication is set not to be performed, the authentication process unit associates a terminal having the strongest radio wave received by the short-distance wireless communication unit as the short-distance wireless communication terminal with the user at a time when the first authentication is successful, and resets the first authentication and the operation screen when the strength of the radio wave from the terminal detected by the short-distance wireless communication unit becomes smaller than the threshold value.

### Aspect 7

In the information processing apparatus according to any one of Aspects 1 to 6, the authentication process unit causes a setting screen for selecting whether to reset the operation screen to be displayed on the operation screen when the monitor unit detects that the user has left the predetermined system beyond the predetermined range after the user authentication based on the identification information.

### Aspect 8

In the information processing apparatus according to any one of Aspects 1 to 7, the monitor unit includes a timer, and the authentication process unit determines that the user has left the predetermined system beyond the predetermined range and resets the authentication information of the user or the operation screen of the predetermined system when input operation to the operation screen is not received for a predetermined time from the time of the user authentication based on the identification information.

### Aspect 9

An image forming apparatus includes the information processing apparatus according to any one of Aspects 1 to 8, and an image forming system. The predetermined system is the image forming system.

### Aspect 10

An information processing method includes storing user information including identification information for identifying a user who uses a predetermined system, monitoring presence of the user who uses the predetermined system, authenticating the user based on the user information, resetting authentication information of the user or an operation screen of the predetermined system when, by the monitoring, it is detected that the user has left the predetermined system beyond the predetermined range after user authentication and before the user completes a use of the predetermined system.

### Aspect 11

A program which, when executed by one or more computers, causes the one or more computers to perform an information processing method. The information processing method includes storing user information including identification information for identifying a user who uses a predetermined system, monitoring presence of the user who uses the predetermined system, authenticating the user based on the user information, and resetting authentication information of the user or an operation screen of the predetermined system when, by the monitoring, it is detected that the user has left the predetermined system beyond the predetermined range after user authentication and before the user completes a use of the predetermined system.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus comprising:
a memory that stores user information of one or more users who are authorized to use a predetermined system, the user information including user identification information for identifying each user; and
circuitry configured to
monitor presence of a user who uses the predetermined system,
authenticate the user based on the user information of the user, and
reset authentication information of the user or an operation screen of the predetermined system, when the circuitry detects that the user has left the predetermined system beyond a predetermined range after authentication of the user and before the user completes a use of the predetermined system.

2. The information processing apparatus according to claim 1, wherein
the user information further includes card information of a card that enables the user to use the predetermined system or biological information of the user,
the authentication includes first authentication and second authentication,
after performing the first authentication based on the card information or the biological information, the circuitry causes the operation screen to display an input screen for inputting a password of the user to be used for the second authentication, and
when the circuity detects that the user has left the predetermined system beyond the predetermined range after the input screen is displayed, the circuitry resets the authentication information of the first authentication and the input screen.

3. The information processing apparatus according to claim 1, wherein
the user information further includes terminal information on a short-distance wireless communication terminal of the user,
the circuitry monitors using a short-distance wireless communication device that performs short-distance wireless communication with the short-distance wireless communication terminal, and
the circuitry resets the authentication information of the user and the operation screen, when strength of radio wave from the short-distance wireless communication terminal received by the short-distance wireless communication device becomes smaller than a threshold value.

4. The information processing apparatus according to claim 3, wherein
the user information further includes card information of a card that enables the user to use the predetermined system,
the authentication includes zeroth authentication and first authentication, and
the circuitry causes the operation screen to display an error screen when a user authenticated by the first authentication using the card information and a user authenticated by the zeroth authentication using the terminal information do not match.

5. The information processing apparatus according to claim 4, wherein
the circuitry causes the operation screen to display a setting screen for allowing the user to select whether to perform the zeroth authentication based on the terminal information.

6. The information processing apparatus according to claim 5, wherein, when a setting by the setting screen indicates that the zeroth authentication is not to be performed,
the circuitry is configured to
associate, as the short-distance wireless communication terminal of the user, a terminal having the strongest radio wave received by the short-distance wireless communication device, with the user at a time when the first authentication is successful, and
reset the authentication information of the first authentication and the operation screen when the strength of the radio wave from the terminal received by the short-distance wireless communication device becomes smaller than the threshold value.

7. The information processing apparatus according to claim 1, wherein
the circuitry causes the operation screen to display a setting screen that allows the user to select whether to reset the operation screen, when the circuitry detects that the user has left the predetermined system beyond the predetermined range after the authentication of the user.

8. The information processing apparatus according to claim 1, wherein
the circuitry monitors using a timer, and
the circuitry determines that the user has left the predetermined system beyond the predetermined range and resets the authentication information of the user or the operation screen of the predetermined system, when input operation to the operation screen is not received for a predetermined period of time from a time when the authentication of the user is performed.

9. An image forming apparatus comprising:
the information processing apparatus according to claim 1; and
the predetermined system, the predetermined system being an image forming system that forms an image.

10. An information processing method comprising:
storing, in a memory, user information of one or more users who are authorized to use a predetermined system, the user information including user identification information for identifying the user;
monitoring presence of a user who uses the predetermined system;
authenticating the user based on the user information of the user; and
resetting authentication information of the user or an operation screen of the predetermined system, when the monitoring detects that the user has left the predetermined system beyond a predetermined range after authentication of the user and before the user completes a use of the predetermined system.

11. A non-transitory recording medium storing a plurality of instructions which, when executed by one or more processors, causes the one or more processors to perform a method, the information processing method comprising:
storing, in a memory, user information of one or more users who are authorized to use a predetermined system, the user information including user identification information for identifying the user;
monitoring presence of a user who uses the predetermined system;
authenticating the user based on the user information of the user; and
resetting authentication information of the user or an operation screen of the predetermined system, when the monitoring detects that the user has left the predetermined system beyond a predetermined range after authentication of the user and before the user completes a use of the predetermined system.
